(19) United States
(12) Patent Application Publication
(10) Pub. No.: US 2012/0099196 A1
(43) Pub. Date: Apr. 26, 2012

(54) ATTACHMENT DEVICE FOR A PAIR OF BINOCULARS

(76) Inventors: Johnny L. Wood, Pinellas Park, FL (US); Donald L. Springer, Naples, FL (US)

(21) Appl. No.: 12/909,915

(22) Filed: Oct. 22, 2010

(51) Int. Cl. G02B 27/02

(52) U.S. Cl. 359/480

(57) ABSTRACT

An attachment device (1) that attaches a pair of binoculars (3) to the brim (4) of a hat (2) via a clip (5). The attachment device has a series of arms (7, 10, 13) that are pivotally attached to each other and to the clip, thereby allowing a user to flip the binoculars upward in a stored position on top of the brim or downward so that the user can look through the binoculars. The pivoting arms further allow a user to adjust the binoculars up or down depending on the position of a user's eyes in relation to the brim of the hat. In addition, the pivoting arms are slidably attached to the clip via slides (6), thereby allowing a user to adjust the distance between his or her eyes and the binoculars. An optional strap (20) may be worn around the user's head to provide additional support to the attachment device and binoculars.

### BACKGROUND OF THE INVENTION

This invention relates to binoculars, more particularly, an adjustable device for attaching a pair of binoculars to the brim of a hat that allows a user to use the binoculars while keeping his or her hands free.

Binoculars are commonly used for sporting events, concerts, bird and animal watching, hunting, surveillance and scenery viewing to magnify a distant point. For example, in sporting events at large arenas spectators may be far away from the players on the field. Accordingly, spectators bring binoculars to more easily see the activities occurring on the field. A drawback of current binoculars is the need to hold the binoculars to your face while looking through them. This can leave users at a disadvantage, especially those who need the use of their hands for other purposes, such as hunters. This can also cause physical discomfort to the user due to the muscular fatigue caused by holding the binoculars up to the user's face for extended periods of time.

Therefore, a need exists for a device which will allow a user to mount a pair of binoculars to a brim of a hat so that a user can look through the binoculars while using their hands for other purposes.

The relevant prior art includes the following patent references:

| Patent/Serial No. | Inventor | Issue/Publication Date |
|---|---|---|
| U.S. References | | |
| 7,340,781 | Clark | Mar. 11, 2008 |
| 7,240,374 | Fang | Jul. 10, 2007 |
| 2006/0126013 | Himmele | Jun. 15, 2006 |
| 2006/0037125 | McDowell | Feb. 23, 2006 |
| 2005/0111097 | Iannarelli et al. | May 26, 2005 |
| 2004/0070823 | Radna | Apr. 15, 2004 |
| 6,639,958 | Himmele | Apr. 09, 2002 |
| 6,172,808 | Foreman et al. | Jan. 09, 2001 |
| 6,115,846 | Truesdale | Sep. 12, 2000 |
| 5,526,178 | Goldstein et al. | Jun. 11, 1996 |
| 5,179,735 | Thomanek | Jan. 19, 1993 |
| 5,150,255 | Lin | Sep. 22, 1992 |
| 4,807,987 | Bastable et al. | Feb. 28, 1989 |
| 4,637,536 | Wong | Jan. 20, 1987 |
| 2,848,924 | Potez | Aug. 26, 1958 |
| 2,649,019 | Hartline et al. | Aug. 18, 1953 |
| 2,625,855 | Gaylor | Jan. 20, 1953 |
| 2,517,892 | Larrabee et al. | Aug. 08, 1950 |
| 2,452,522 | Ellis | Aug. 12, 1947 |
| Foreign References | | |
| CN201281781 | Xiaoli et al. | Jul. 29, 2009 |
| KR20080009387 | Park | Jan. 29, 2008 |
| JP2003166112 | Matsunaga | Jun. 13, 2003 |
| CN2297738 | Gao | Nov. 18, 1998 |
| CN2282692 | Guo et al. | May 27, 1998 |
| CN2243199 | Liang | Dec. 25, 1996 |
| CN2075347 | Jinzhe | Apr. 17, 1991 |
| GB8827329 | Choi | Dec. 29, 1988 |

### SUMMARY OF THE INVENTION

The primary object of the present invention is to provide an attachment device for a pair of binoculars that allows a user to mount a pair of binoculars to a brim of a hat.

Another object of the present invention is to provide an attachment device for a pair of binoculars that allows a user to look through the binoculars while his or her hands remain free to perform other tasks.

A further object of the present invention is to provide an attachment device for a pair of binoculars that allows a user to place the binoculars in a stored position on top of a brim of a hat.

The present invention fulfills the above and other objects by providing an attachment device that uses a clip to attach a pair of binoculars to the brim of a hat, such as a baseball cap, visor, fishing hat, golfing hat, helmet, hard hat, etc. The device comprises a series of arms that are pivotally attached to each other and to the clip, thereby allowing a user to flip the binoculars upward in a stored position on top of the brim or downward below the brim so the user can look through the binoculars. The pivoting arms further allow a user to adjust the binoculars up or down depending on the position of a user's eyes in relation to the brim of the hat. In addition, the pivoting arms are slidably attached to the clip, thereby allowing a user to adjust the distance between his or her eyes and the binoculars. An optional strap may be worn around the user's head to provide additional support to the attachment device and binoculars.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective side view of an attachment device for a pair of binoculars of the present invention attached to a hat and in an upward and stored position;

FIG. 2 is a side view of an attachment device for a pair of binoculars of the present invention with optional strap attached to a hat and in a downward use position;

FIG. 3 is a side view of an attachment device for a pair of binoculars of the present invention;

FIG. 4 is a front view of an attachment device for a pair of binoculars of the present invention having two clips and folded flat; and

FIG. 5 is a front view of an attachment device for a pair of binoculars of the present invention having a single clip and folded flat.

### DESCRIPTION OF THE PREFERRED EMBODIMENTS

For purposes of describing the preferred embodiment, the terminology used in reference to the numbered components in the drawings is as follows:

| | |
|---|---|
| 1. | attachment device |
| 2. | hat |
| 3. | binoculars |
| 4. | brim |
| 5. | clip |
| 6. | slide |
| 7. | bottom arm |
| 8. | first end of bottom arm |
| 9. | second end of bottom arm |
| 10. | middle arm |
| 11. | first end of middle arm |
| 12. | second end of middle arm |
| 13. | top arm |
| 14. | first end of top arm |
| 15. | second end of bottom arm |
| 16. | bracket |
| 17. | attachment means |
| 18. | screw |
| 19. | cross member |
| 20. | strap |
| 21. | adjustment means |

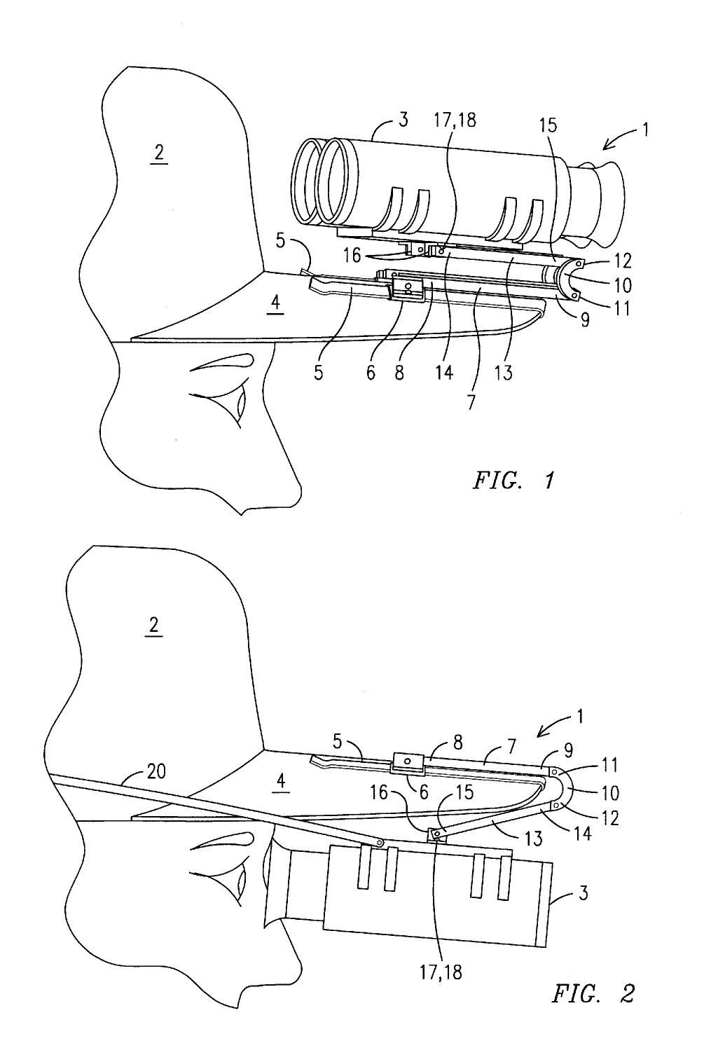

With reference to FIG. 1, a perspective side view of an attachment device 1 of the present invention attached to a hat 2 and in an upward and stored position is shown. The binocular attachment device 1 attaches a pair of binoculars 3 to a brim 4 of a hat 2 and comprises at least one substantially U-shaped clip 5 that attaches to the hat 2 by sandwiching the brim 4 between the at least one clip 5. As shown here, the binocular attachment device 1 has two clips 5. Slides 6 are slidably attached to each clip 5. The slides 6 allow a user to adjust the binoculars 3 forward and backward, thereby adjusting the distance between the binoculars 3 and the users head and face. Two bottom arms 7 each have a first end 8 and a second end 9. The first end 8 of each bottom arm 7 is pivotally attached to each slide 6. Two middle arms 10 each have a first end 11 and a second end 12. The first end 11 of each middle arm 10 is pivotally attached to the second end 9 of each bottom arm 7. Two top arms 13 each have a first end 14 and a second end 15. The first end 14 of each top arm 13 is pivotally attached to the second end the 12 of each middle arm 10. The second end 15 of each top arm 13 is pivotally attached to a bracket 16, which may be integral to the binoculars 3 or attached to the binoculars 3 via an attachment means 17, such as screws 18, nuts, bolts, adhesive, hook and loop fastener, clamps, etc.

With reference to FIG. 2, a side view of an attachment device 1 of the present invention with an optional strap attached to a hat 2 and in a downward use position is shown. The attachment device 1 comprises at least one substantially U-shaped clip 5 that attaches to the hat 2 by sandwiching the brim 4 between the at least one clip 5. Slides 6 are slidably attached to each clip 5. The slides 6 allow a user to adjust the binoculars 3 forward and backward, thereby adjusting the distance between the binoculars 3 and the users eyes when the binocular attachment device 1 is in a downward position. Two bottom arms 7 each have a first end 8 and a second end 9. The first end 8 of each bottom arm 7 is pivotally attached to each slide 6. Two middle arms 10 each have a first end 11 and a second end 12. The first end 11 of each middle arm 10 is pivotally attached to second end 9 of each bottom arm 7. The middle arms 10 may be straight or curved, as shown herein, to provide additional clearance for the brim 4 of the hat 2 when the attachment device 1 is in a folded down position. Two top arms 13 each have a first end 14 and a second end 15. The first end 14 of each top arm 13 is pivotally attached to the second end 12 of each middle arm 10. The second end 15 of each top arm 13 is pivotally attached to a the bracket 16, which may be integral to the binoculars 3 or attached to the binoculars 3 via an attachment means 17, such as screws 18, nuts, bolts, adhesive, hook and loop fastener, clamps, etc. An optional strap 20 may be worn around the user's head to provide additional support to the attachment device 1 and binoculars 3 to hold the firmly on the user's head. The strap 20 may be one strap that is placed around the user's entire head or multiple straps 20 that attach to the side of a hat.

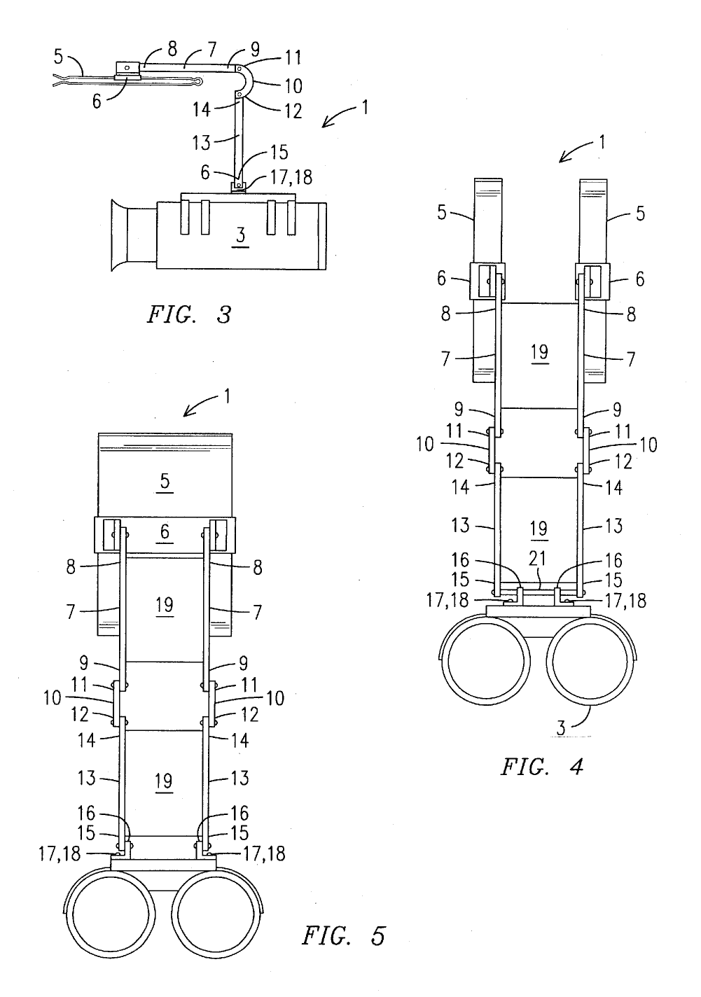

With reference to FIG. 3, a side view of an attachment device 1 of the present invention is shown. The attachment device 1 comprises at least one substantially U-shaped clip 5 a brim 4 of a hat 2. Slides 6 are slidably attached to each clip 5. The slides 6 allow a user to adjust the binoculars 3 forward and backward, thereby adjusting the distance between the binoculars 3 and the users eyes when the attachment device 1 is in a downward position. Two bottom arms 7 each have a first end 8 and a second end 9. The first end 8 of each bottom arm 7 is pivotally attached to each slide 6. Two middle arms 10 each have a first end 11 and a second end 12. The first end 11 of each middle arm 10 is pivotally attached to the second end 9 of each bottom arm 7. The middle arms 10 may be straight or curved, as shown herein, to provide additional clearance for the brim 4 of the hat 2 when the attachment device 1 is an a folded down position. Two top arms 13 each have a first end 14 and a second end 15. The first end 14 of each top arm 13 is pivotally attached to the second end 12 of each middle arm 10. The second end 15 of each top arm 13 is pivotally attached to a bracket 16, which may be integral to the binoculars 3 or attached to the binoculars 3 via an attachment means 17, such as screws 18, nuts, bolts, adhesive, hook and loop fastener, clamps, etc.

With reference to FIG. 4, a front view of an attachment device 1 of the present invention having two clips 5 and folded flat is shown. As shown here, the attachment device 1 comprises two substantially U-shaped clips 5 for attachment to a brim 4 of a hat 2. Slides 6 are slidably attached to each clip 5. The slides 6 allow a user to adjust the binoculars 3 forward and backward, thereby adjusting the distance between the binoculars 3 and the users eyes when the attachment device 1 is in a downward position. Two bottom arms 7 each have a first end 8 and a second end 9. The first end 8 of each bottom arm 7 is pivotally attached to each slide 6. Two middle arms 10 each have a first end 11 and a second end 12. The first end 11 of each middle arm 10 is pivotally attached to the second end 9 of each bottom arm 7. The middle arms 10 may be straight or curved, as shown herein, to provide additional clearance for the brim 4 of the hat 2 when the attachment device 1 is an a folded down position. Two top arms 13 each have a first end 14 and a second end 15. The first end 14 of each top arm 13 is pivotally attached to the second end 12 of each middle arm 10. The second end 15 of each top arm 13 is pivotally attached to a bracket 16 via an adjustment means 21. The brackets 16 which may be integral to the binoculars 3 or attached to the binoculars 3 via an attachment means 17, such as screws 18, nuts, bolts, adhesive, hook and loop fastener, clamps, etc. The brackets 16 slidably attached to the adjustment means 21 to allow a user to adjust the distance between to brackets 16 in order to accommodate various sizes of binoculars. The top arms 13, middle arms 10 and/or bottom arms 7 may have cross members 19 connecting each together to provide additional stability to the attachment device 1.

With reference to FIG. 5, a front view of an attachment device 1 of the present invention having a single clip 5 and folded flat is shown. The attachment device 1 comprises a substantially U-shaped clip 5 for attachment to a brim 4 of a hat 2. A slide 6 is slidably attached to the clip 5. The slide 6 allows a user to adjust the binoculars 3 forward and backward, thereby adjusting the distance between the binoculars 3 and the users eyes when the attachment device 1 is in a downward position. Two bottom arms 7 each have a first end 8 and a second end 9. The first end 8 of each bottom arm 7 is pivotally attached to each slide 6. Two middle arms 10 each have a first end 11 and a second end 12. The first end 11 of each middle arm 10 is pivotally attached to the second end 9 of each bottom arm 7. The middle arms 10 may be straight or curved, as shown herein, to provide additional clearance for the brim 4 of the hat 2 when the attachment device 1 is an a folded down position. Two top arms 13 each have a first end 14 and a second end 15. The first end 14 of each top arm 13 is pivotally attached to the second end 12 of each middle arm 10. The second end 15 of each top arm 13 is pivotally attached to a bracket 16, which may be integral to the binoculars 3 or attached to the binoculars 3 via an attachment means 17, such as screws 18, nuts, bolts, adhesive, hook and loop fastener, clamps, etc. The top arms 13, middle arms 10 and/or bottom arms 7 may have cross members 19 connecting each together to provide additional stability to the attachment device 1.

It is to be understood that while a preferred embodiment of the invention is illustrated, it is not to be limited to the specific form or arrangement of parts or use herein described and shown. It will be apparent to those skilled in the art that various changes may be made without departing from the scope of the invention and the invention is considered not to be limited to what is shown and described in the specification and drawings.

Having thus described my invention, I claim:

1. An attachment device for attaching a pair of binoculars to a brim of a hat, said binocular attachment device comprising:
at least one clip for attaching the binocular attachment device to the brim of the hat;
at least one bottom arm having a first end and a second end, said first end of the at least one bottom arm being pivotally attached to the at least one clip;
at least one middle arm having a first end and a second end, said first end of the at least one middle arm being pivotally attached to the second end of the at least one bottom arm; and
at least one top arm having a first end and a second end, said first end of the at least one top arm being pivotally attached to a bracket.

2. The attachment device of claim 1 wherein:
said bracket is integral to a pair of binoculars.

3. The attachment device of claim 1 wherein:
said bracket is attached to a pair of binoculars via an attachment means.

4. The attachment device of claim 3 wherein:
said attachment means is at least one screw.

5. The attachment device of claim 3 wherein:
said attachment means is at least one bolt

6. The attachment device of claim 3 wherein:
said attachment means is an adhesive.

7. The attachment device of claim 3 wherein:
said attachment means is a hook and loop fastener.

8. The attachment device of claim 3 wherein:
said attachment means is at least one clamp.

9. The attachment device of claim 1 further comprising:
at least one cross member located on the at least one top arm.

10. The attachment device of claim 1 further comprising:
at least one cross member located on the at least one middle arm.

11. The device of claim 1 further comprising:
at least one cross member located on the at least one bottom arm.

12. The attachment device of claim 1 wherein:
the at least one middle arm is curved.

13. The attachment device of claim 1 further comprising:
at least one strap for securing the binocular attachment device around a user's head.

14. The attachment device of claim 1 further comprising:
the bracket is connected to the at least one top arm via an adjustment means.

15. A attachment device for attaching a pair of binoculars to a brim of a hat, said binocular attachment device comprising:
at least one clip for attaching the binocular attachment device to the brim of the hat; and
at least one slide slidably attached to the at least one clip for adjusting the placement of the binoculars forward or backward.
at least one bottom arm having a first end and a second end, said first end of the at least one bottom arm being pivotally attached to the at least one slide;
at least one middle arm having a first end and a second end, said first end of the at least one middle arm being pivotally attached to the second end of the at least one bottom arm;
at least one top arm having a first end and a second end, said first end of the at least one top arm being pivotally attached to a bracket.

16. The attachment device of claim 15 wherein:
said bracket is integral to a pair of binoculars.

17. The attachment device of claim 15 wherein:
said bracket is attached to a pair of binoculars via an attachment means.

18. The attachment device of claim 17 wherein:
said attachment means is at least one screw.

19. The attachment device of claim 17 wherein:
said attachment means is at least one bolt

20. The attachment device of claim 17 wherein:
said attachment means is an adhesive.

21. The attachment device of claim 17 wherein:
said attachment means is a hook and loop fastener.

22. The attachment device of claim 17 wherein:
said attachment means is at least one clamp.

23. The attachment device of claim 15 further comprising:
at least one cross member located on the at least one top arm.

24. The attachment device of claim 15 further comprising:
at least one cross member located on the at least one middle arm.

25. The attachment device of claim 15 further comprising:
at least one cross member located on the at least one bottom arm.

26. The attachment device of claim 15 wherein:
the at least one middle arm is curved.

27. The attachment device of claim 15 further comprising:
at least one strap for securing the binocular attachment device around a user's head.

28. The attachment device of claim 15 further comprising:
the bracket is connected to the at least one top arm via an adjustment means.
